(19) United States
(12) Patent Application Publication
(10) Pub. No.: US 2006/0266444 A1
(43) Pub. Date: Nov. 30, 2006

(54) Electrolytically coated cold-rolled strip, preferably to be used for the production of battery shells, and method for coating the same

(75) Inventors: Helmut Kosslers, Schwalmtal (DE); Tilman Strotbek, Dusseldorf (DE)

Correspondence Address: HARNESS, DICKEY & PIERCE, P.L.C., P.O. BOX 828, BLOOMFIELD HILLS, MI, 48303, US

(73) Assignee: HILLE & MULLER GMBH, Dusseldorf (DE)

(21) Appl. No.: 10/552,099

(22) PCT Filed: Apr. 8, 2004
(86) PCT No.: PCT/EP04/03794

§ 371 Date: Jul. 21, 2006

(30) Foreign Application Priority Data
Apr. 11, 2003 (DE) 103 16 612.2

(51) Int. Cl. C25D 5/12; B32B 15/18

(52) U.S. Cl. 148/518; 205/181; 428/679

(57) ABSTRACT

Disclosed is a cold-rolled strip, at least one face of which is provided with an electrolytically applied coating, preferably to be used for producing battery shells by means of deep drawing and/or ironing. The electrolytically applied coating comprises two layers, i.e. a hard and brittle bright nickel layer and a cobalt-containing layer that is applied thereupon. The aim of the invention is to be able to produce such a cold-rolled strip in a more economic manner while a battery shell produced by reshaping said cold-rolled strip is to have good contact resistance to the electrolyte and good storage stability. Said aim is achieved by using a matte cobalt layer which is removed from an electrolyte bath without adding brighteners, or a matte cobalt alloy layer as the cobalt-containing layer. Also disclosed are a method for electrolytically coating a cold-rolled strip and a battery shell which is produced from such a cold-rolled strip by means of a reshaping process.

The invention is directed to a cold-rolled strip, at least one face of which is provided with an electrolytically applied coating, preferably for use in the manufacture of battery shells by means of deep drawing and/or ironing, wherein the electrolytically applied coating comprises at least two layers, namely a hard and brittle bright nickel layer and a cobalt-containing layer that is applied thereon. The invention is further directed to a method of electrolytically coating a cold-rolled strip with a coating formed of at least two layers.

In order for alkali batteries to have a good power characteristic, it is necessary to minimize the internal resistance of the battery. For this, the contact resistance between the battery shell, which serves as the current feeder, and the active cathode mass must be held as low as possible. In order to achieve this, the largest possible contact surface between the interior side of the battery cup and the cathode mass is particularly desired. For enlarging the contact surface on the interior side of the battery shell, the prior art provides a cold-rolled strip for use in the manufacture of battery shells and with an electrolytically isolated, hard and thereby brittle metal coating, which tears during forming of the cup formed battery shells through deep drawing and/or ironing, and thereby leading to the desired reduction of the contact resistance between the cathode mass of the battery and the interior surface of the battery shell.

The hard and brittle metal coatings are described as hard and brittle bright nickel layers (e.g., in EP 0 629 009 B1 and in EP 0 809 307 A2). The bright nickel layer tears during forming using deep drawing and/or ironing, and defines a plurality of small plate formed sections separated by tears and thereby an enlarged surface.

As an alternative and a supplement to bright nickel, WO 01/27355 A1 suggests a layer formed from cobalt and a cobalt alloy, which comprises decomposition and reaction products from organic substances (so-called brighteners). This bright cobalt and bright cobalt alloy layer is, similar to the bright nickel layer described in the above-identified documents, hard and brittle and tears during forming of the cold-rolled strip to a battery shell through deep drawing and/or ironing under surface enlargement. Cobalt and cobalt alloys have an advantage over nickel, in that the oxide and hydroxide of the cobalt that forms on the inner surface of the battery shell with the storage and/or use of an electrolyte filled battery formed includes a better electrical conductivity as compared to nickel oxide and nickel hydroxide. Cobalt, however, is a more expensive material in comparison to nickel. Furthermore, the separation of bright cobalt and a bright cobalt alloy can occur only at comparatively low current densities due to the organic additives contained in the electrolyte bath, which leads to a slow separation and a correspondingly long duration of the to be coated cold-rolled strip in the electrolyte bath.

Starting from the described prior art, the object of the present invention is to provide a cold-rolled strip, which is economically manufacturable, and can be manufactured into battery shells through deforming, deep drawing and/or ironing in particular, which provides a minimized electrical contact resistance between the cathode mass and the interior surface of the cup formed battery shell and features an excellent storage duration. Further, a method of manufacturing such a cold-rolled band should be provided.

In resolving the cold-rolled strip directed object, the present invention provides that the cobalt-containing layer, in a cold-rolled strip of the initially named kind, is an isolated matte cobalt or a matte cobalt alloy layer from an electrolyte bath without brighteners.

The basis of the invention is the surprising realization that a mostly ductile and good formable matte cobalt layer or matte cobalt alloy layer on a thereunder lying bright nickel layer tears together with the thereunder lying bright nickel layer during forming of the cold-rolled strip into a battery shell through deep drawing and/or ironing, and results in a surface enlargement. Therewith, the matte cobalt layer or matt cobalt alloy layer does not behave as expected, because of its ductility, such that the forming process results without appreciable or with reduced tear formation as compared to bright nickel.

This realization allows a cold-rolled strip with the claimed electrolytically applied layer order to be used for the manufacture of battery shells. Such a cold-rolled strip can be economically manufactured on the basis of the abandonment of the organic additives in the cobalt containing electrolytes. Higher current densities can be introduced with the cobalt separation because of the not present organic additives, as compared to a bright cobalt separation, which, with equivalent bath lay-outs, leads to an increased capacity and thereby to an improved efficiency in the manufacture.

At the same time arises a comparison between a cold-rolled strip that is only coated with a bright cobalt layer with a cold-rolled strip configured in accordance with the invention and formed into a battery shell, which includes at least identical conductivity with very good durability and therewith storability. The exclusive ductile matte cobalt layer and matte cobalt alloy layer can additionally be achieved comparatively thin, namely in the range between 0.01 to 0.2 μm, preferably 0.01 to 0.05 μm, which, compared to comparatively strong bright cobalt layers, enables a savings of cobalt material and a cost reduction therewith.

Electrically conductive particles can be contained in the matte cobalt layer or matte cobalt alloy layer to improve the electrical conductivity of battery shells formed from the cold-rolled strip using deep drawing and/or ironing, like for example, graphite, carbon black, TiN and/or additives to nickel, iron, tin, indium, palladium, gold and/or bismuth. With such additives the conductivity of the so coated cold-rolled strip can be again increased and thereby the contact resistance of a battery shell produced from the cold-rolled strip can be again decreased.

In accordance with a further advantageous extension of the invention, a steel with a carbon content of less than 0.20% and a thickness of up to 1 mm is used as a metallic carrier material. The thickness preferably lies between 0.1 and 0.7 mm. Such a steel is particularly suitable as a base material for the manufacture of battery shells. The carrier material can be provided underneath the bright nickel layer with a first, further coating. Such a coating can be a nickel layer, for example, which preferably is formed as a ductile matte nickel layer. This ensues with forming of the cold-rolled strip into the battery shell without appreciable tear formation and forms thereby a corrosion protection on the base material of the carrier material. This nickel layer can be transferred through thermal treatment, for example diffusion annealing, into the area of the carrier material, so that it forms an Fe—Ni alloy zone with a steel carrier material. =p The thickness of the bright nickel layer amounts to preferably less than 2 μm, particularly less than 1 μm.

A method, which achieves the above-named objective, is a method of electrolytically coating a cold-rolled strip with a coating formed from at least two layers, wherein a brittle nickel layer from a nickel ion and organic additive containing electrolyte bath is initially deposited and which is of a decomposition product of these additives and/or a reaction product, and afterwards a ductile cobalt layer or cobalt alloy layer is deposited on this nickel layer from an organic additive free, cobalt containing electrolyte bath.

With such a method, a cold-rolled strip is coated and an above-described electrolytic coated cold-rolled strip is achieved. The method in accordance with the invention characterizes itself through its simplicity and economy, because an organic additive, in particular so-called bright forming, free cobalt containing electrolyte with high current density and corresponding high deposition speed can be practiced.

Between the deposition of the brittle nickel and the deposition of the ductile cobalt, the cold-rolled band can be subjected to a flushing action.

To the electrolytes for the deposition of the nickel layer are preferably added organic brightening additives, so-called secondary brighteners, in particular butindiol, with or without addition of so-called primary brightener carriers, in particular sodium o-benzosulfamide (saccharin). Such secondary brighteners lead to a brittle bright nickel layer, which shows the desired tear formation with forming of the cold-rolled strip through deep drawing and/or ironing.

In order to further improve the conductivity of the ductile cobalt layer or cobalt alloy layer, particles of graphite, carbon black, TiN and/or ions of nickel, iron, tin, palladium, gold and/or bismuth can be added to the electrolytes used in its deposition.

The deposition of the brittle nickel layer can occur at current densities between 8 and 16 A/dm², preferably at 16 A/dm², the deposition of the ductile cobalt layer or cobalt alloy layer at current densities between 10 and 20 A/dm², preferably 16 A/dm².

In the case that a corrosion inhibiting layer should be deposited on the cold-rolled strip before the deposition of the brittle nickel layer (bright nickel layer), can hereto a first, ductile nickel layer be deposited, wherein this deposition preferably can be achieved electrolytically or through PVD (physical vapor deposition).

One achieves further improved forming and corrosion protective characteristics of the first, ductile nickel layer if the cold-rolled strip is diffusion annealed and possibly also post rolled after the application of this nickel layer. One achieves still better forming and corrosion protective characteristics if the cold-rolled strip is still cold rolled and then first diffusion annealed and possibly also post rolled.

Finally, a battery shell is provided with the invention, which is manufactured through forming, in particular deep drawing and/or ironing of a cold-rolled strip of the above-described type.

A particular advantage is that with the inventive cold-rolled strip, the brittle nickel layer together with the thereon disposed ductile matte cobalt layer or matte cobalt alloy layer always tears in a form with which the tears run not only in the longitudinal direction of the battery shell but especially also at an angle from approximately 45° thereto. This is therefore of particular advantage because with the completion of the batteries a cathode material, which is previously compressed into so-called “pellets”, is generally pressed into the battery shell. These are rings or discs from a mixture of manganese dioxide, carbon, caustic potash and a binding material. With pressing of these rings in the battery cup an appropriate contact is sought for the conduction of electrons. Because tears also appear at an angle of approximately 45° to the deformation direction using the battery shell manufactured the cold-rolled strip in accordance with the invention, a portion of this cathode material can be inserted with the introduction of the pellets into the tears that run angularly to the press direction. This leads to a particularly good contact of the cathode material to the inner side of the battery shell.

This advantage of the improved contact goes along with the advantage of a good storability of a battery shell, which is coated on its interior side with cobalt. As a result batteries can be manufactured from the battery shells of the present invention, which feature not only an excellent contact of the cathode matter to the interior side of the battery shell on the basis of the torn surface, especially which additional thereto further features an excellent storability because of the implemented cobalt.

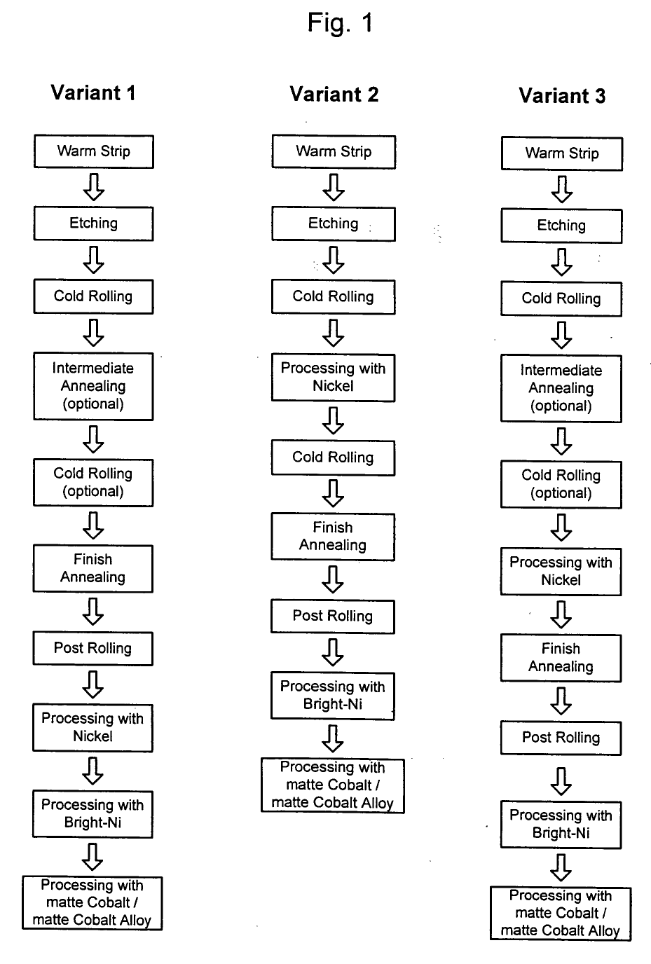

Following, the invention will be more precisely described considering an exemplary embodiment in comparison to traditionally completed, in accordance with the prior art, cold-rolled strips as well as battery shells formed therefrom in reference to the attached FIGS. 1 through 3. Therewith:

FIG. 1 schematically illustrates the process cycle of an inventive cold-rolled strip according to 3 variants,

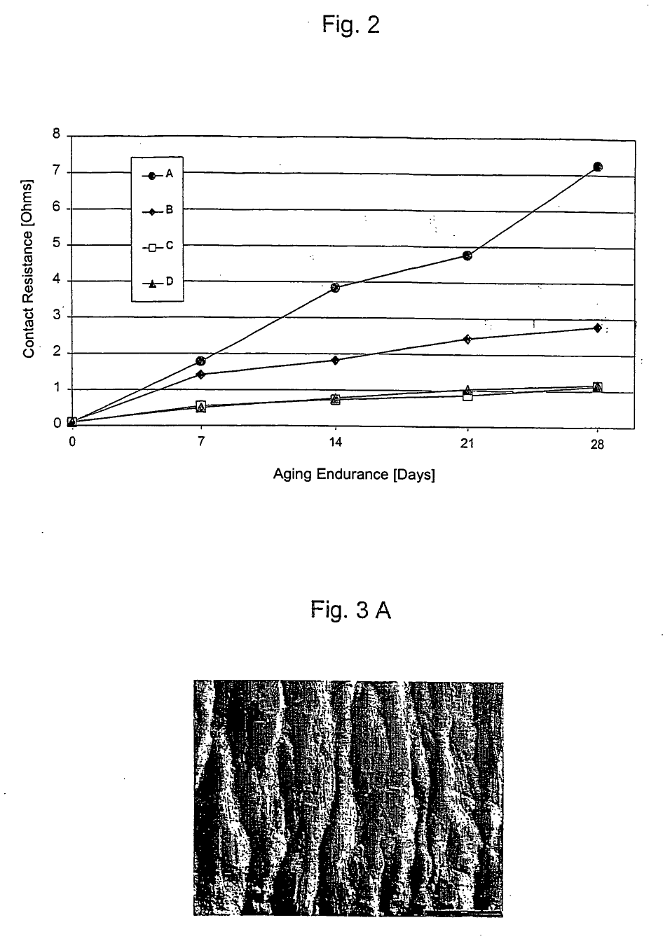

FIG. 2 illustrates a representative graph of the influence of the cold-rolled strip coating on the contact resistance in dependence on the aging endurance for the exemplary embodiment of the invention as well as 3 comparison examples, and

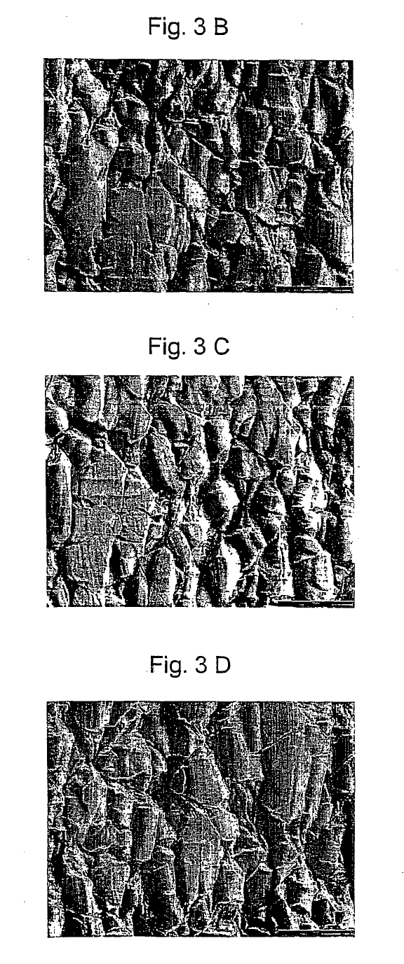

FIG. 3 illustrates the surface structure of the shell interior side in dependence on the surface coating in accordance with the exemplary embodiment and the comparison examples in topographical REM-photos in the scale of 360:1.

For comparison a nickel pre-coated cold-rolled strip is used as a cold-rolled strip substrate, wherein the pre-coating through to post rolling can occur in accordance with one of the in FIG. 1 illustrated variants 1 through 3. That means in accordance with variant 1, the warm strip is initially etched, then cold rolled, then possibly also intermediate annealed and again cold rolled, finish annealed and post rolled, before the nickel pre-coating occurs. In the variant 2, the warm strip is initially etched, then cold rolled, subsequently pre-coated with nickel, then again cold rolled, finish annealed and post rolled. In a third variant the warm strip is initially etched, then cold rolled, possibly also intermediate annealed and cold rolled, pre-coated with nickel, subsequently finish annealed and post rolled. The pre-coating with nickel can occur electrolytically or possibly also through PVD deposition.

For the accomplishment of comparison measurements 4 sample plates were manufactured with different coatings in accordance with the following Table 1.

TABLE 1

| | | | Bright Ni | Coating of the |
|---|---|---|---|---|
| | Co Coating | Type of Co | Coating | Ni Pre- |
| Sample | [μm] | Coating | [μm] | Coating |
| A | — | — | — | 2 |
| B | — | — | 1 | 0.7 |
| C | 0.05 | matte | 0.9 | 0.7 |
| D | 0.2 | bright | 0.8 | 0.7 |

A matte nickeled, subsequently diffusion annealed and post rolled cold-rolled strip with a nickel layer thickness of 2 μm (Sample A) serves as a typical standard material for the manufacture of battery shells. Further a cold-rolled strip material (Sample B) was manufactured, which includes a diffusion annealed base coating of 0.7 μm matte nickel. A brittle 1 μm thick bright nickel layer was electrolytically deposited thereon in a second processing step. The deposition of the bright nickel layer occurs with an electrolyte of the in Table 2 identified composition under the there identified process parameters.

A cold-rolled strip material in accordance with the invention was manufactured as Sample C. This includes a diffusion annealed base coating of 0.7 μm matte nickel. A 0.9 μm thick bright nickel layer was deposited thereon in a second processing step with an electrolyte of the in Table 2 illustrated composition and under the process parameters illustrated in this table. On this layer was subsequently deposited a 0.05 μm thick matte cobalt layer. Hereto was used an electrolyte with the in Table 3 provided components and under the further process conditions provided in this table.

Finally a cold-rolled strip material (Sample D) was manufactured in accordance with the teachings of WO 01/27355 A1 for comparison, which includes a diffusion annealed base layer of 0.7 μm. On top of this was first deposited a 0.8 μm thick bright nickel layer and then a 0.2 μm thick bright cobalt layer in a second processing step.

TABLE 2

| | Target Value |
|---|---|
| Nickel [g/l] | 65 |
| Chloride [g/l] | 45 |
| Boric Oxide [g/l] | 35 |
| Brightener A [ml/l] | 11 |
| Brightener B [mg/l] | 200 |
| pH Value | 3.5 |
| Temperature [° C.] | 65 |

Brightener A: Solution with 22 by weight % saccharin;
Brightener B: Butindiol

TABLE 3

| | Target Value |
|---|---|
| Cobalt [g/l] | 65 |
| Chloride [g/l] | 30 |
| Boric Oxide [g/l] | 35 |
| pH Value | 2.3 |
| Temperature [° C.] | 65 |

In order to compare the characteristics of the different coatings after forming, AA battery shells were manufactured from all four variants using deep drawing.

In FIG. 3, four REM photos of surfaces of the interior side of the so manufactured battery shells are identified with A through D. Clear to recognize is that the solely with matte nickel coated Sample A indeed shows a tear formation whereby the tears almost exclusively run in the direction of forming in a disadvantageous manner.

An advantageous tear sample with which, in addition to the tears in the longitudinal direction, tears also develop at an angle of approximately 45° to the forming direction, is shown via the Samples B, C and D. Here, the inventive cold-rolled strip with the cobalt strip on a bright nickel layer deposited matte cobalt layer is seen as well as known cold-rolled strips with only a bright nickel coating and a combination of a bright nickel layer and a bright cobalt layer. This is in this respect surprising, in that it is opposite to what would initially be expected, which is development of a declined tear formation through the use of ductile matte cobalt (Sample C) as compared to a bright cobalt coated sample (Sample D). The pictures show that the samples B, C and D after the forming to a battery shell include an improved surface roughness and therewith include a larger surface as compared to the solely with matte nickel coated sample A.

Using a special measuring apparatus for measurement of the contact resistance, the resistance to aging was determined from tested battery shell material, in order to determine measurement values that are as close to reality as possible, the examined cold-rolled strips have initially been formed to a battery shell, so that in particular in accordance with this invention deposited, brittle coatings depart under enlargement of the surface. Subsequently a circular blank with a predetermined diameter is stamped out of the cut open and flat bent frame. The inspected circular blank is brought into lasting contact with the original shell interior side under a defined pressure and airtight with a standardized cathode material formed from graphite, manganese dioxide and caustic potash and is stored at a temperature of 71° C. over a period of 28 days. During this storage time, the test material is cooled to room temperature at regular intervals and the adapted contact resistance between the cathode material and the inspected cold-rolled strip circular blank is measured. The accelerated aging at 71° C. over a period of 28 days corresponds to an approximate aging at room temperature over a period of 2 years. From experience, the measured results in their trend are fundamentally transferable to real alkaline batteries. The first measurement before the start of the aging commonly indicates an identical contact resistance also for a different coated cold-rolled strip. This is attributable to the fact that the metal surfaces, which up to now have only been in contact with air, still have no substantially developed metal oxide/hydroxide layers formed thereon. Not until the aging under contact with the cathode material is formed a thick metal oxide/hydroxide layer, which then results in an increase of the electrical resistance. In order to now approximately describe the behavior of a strip material in a fresh battery, the contact resistance is preferably observed after 7 days. This approximately corresponds to a storage period at room temperature of approximately ½ year. One can correspond this age to a fresh battery at customer purchase. The in FIG. 2 illustrated results of the aging resistance measurement support the advantageous characteristics of the strip material manufactured in accordance with the invention. The electrical contact resistance of the sample C lies in all phases of aging clearly under the sample A and B measured values and on the same level as with the sample D, the cold-rolled strip with a bright nickel layer and thereon applied bright cobalt layer. Although, as the surface photos show, the sample B includes an approximate identical surface structure as compared with the sample C and D, it includes clearly worse contact resistance measured over the period of the measurement series. This is attributable to the existing cobalt coating with the sample C and D. It is accepted that on the outermost surface of the interior side of the battery shell forms primarily a very stable and good conductive cobalt oxide/hydroxide layer, which includes a clearly higher electrical conductivity than a nickel oxide/hydroxide layer.

Both the results of the microscopic analysis and the measurements of the contact resistance in dependence on the aging period evidences that out of a cold-rolled strip in accordance with the invention a technically equally good product can be manufactured as with a cold-rolled strip in accordance with WO 01/27355 A1. With regard to the achievable productivity and the manufacturing costs, the cold-rolled strip in accordance with the invention includes fundamental advantages over the identified prior art. The thickness of the deposited cobalt/cobalt alloy layer can be reduced by approximately 75% in comparison to WO 01/27355 A1, because it only serves for the formation of a relatively thin, particularly good storable and good electrically conductive cover layer. The deposited layer thickness amounts to a maximum of up to 0.2 μm, preferably however 0.05 μm. In this manner, the material costs for the cobalt containing coating is minimized.

Simultaneously, the current density with the cobalt depositing can be increased over the prior art in accordance with the WO 01/27355 A1 from 10 to a maximum 20 A/dm₂, preferably from 8 to 16 A/dm₂. Because the current density has a direct influence on the productivity of an electrolytic coating process, the new method enables an up to 100% higher productivity with identical layout design.

1. A cold-rolled strip preferably for use in the manufacture of battery shells through deep drawing and/or ironing, comprising: at least one side of the strip being provided with an electrolytically applied coating, wherein the electrolytically applied coating includes at least two layers, a hard and brittle bright nickel layer and a cobalt containing layer applied thereon, and
wherein,
the cobalt containing layer is a matte cobalt layer or matte cobalt alloy layer that is deposited from an electrolyte bath without bright forming additives.

2. A cold-rolled strip in accordance with claim 1, wherein the matte cobalt layer or matte cobalt alloy layer contains electrically conductive particles selected from the group of graphite, carbon black, TiN, and/or additives an nickel, iron, tin, indium, palladium, gold and/or bismuth to improve the electrical conductivity of the battery shell formed through deep drawing and/or ironing of the cold-rolled strip.

3. A cold-rolled strip in accordance with claim 1, wherein a steel with carbon content of less than 0.20% and a thickness of up to 1 mm serves as a metallic carrier material for the two layers.

4. A cold-rolled strip in accordance with claim 1, wherein the metallic carrier material is pre-coated beneath the bright nickel layer on one or both sides.

5. A cold-rolled strip in accordance with claim 4, wherein it is also pre-coated after the application the diffusion annealed nickel layer.

6. A cold-rolled strip in accordance with claim 1, wherein the thickness of the bright nickel layer amounts to less than 2 μm.

7. A cold-rolled strip in accordance with claim 1, wherein the thickness of the cobalt containing layer amounts to 0.01 to 0.2 μm.

8. A method of electrolytically coating a cold-rolled strip with a coating formed from at least two layers, wherein on the cold-rolled strip is initially deposited a layer from a nickel ion and organic additive containing electrolyte bath nickel layer containing a decomposition product of these additives and/or reaction product and afterward is deposited on this nickel layer a ductile cobalt layer or cobalt alloy layer deposited out of an organic bright additive free, cobalt ion containing electrolyte bath.

9. A method in accordance with claim 8, wherein a flushing step occurs between the deposition of the brittle nickel and the deposition of the ductile cobalt/the ductile cobalt alloy laer.

10. A method in accordance with claim 8, wherein the implemented electrolytes organic bright additives for the deposition of the brittle nickel layer, so-called secondary brighteners are added, in particular butindol, with/without addition of so-called primary bright carriers, in particular sodium o-benzosulfamide (saccharin).

11. A method in accordance with claim 8, wherein the electrolyte used for the deposition of the ductile cobalt/the ductile cobalt alloy contains particles of graphite, carbon black, TiN and/or ions of nickel, iron, tin, palladium, gold and/or bismuth.

12. A method in accordance with claim 8, wherein the deposition of the brittle nickel layer occurs at a current density between 8 and 16 A/dm².

13. A method in accordance with claim 8, wherein the deposition of the ductile cobalt layer and the cobalt alloy layer occurs at a current density between 10 and 20 A/dm².

14. A method in accordance with claim 8, wherein on the cold-rolled strip before the electrolytic deposition of the brittle nickel layer a first, ductile nickel layer is deposited, wherein this deposition preferably occurs electrolytically or through PVD.

15. A method in accordance with claim 8, wherein the cold-rolled strip is diffusion annealed and/or post rolled after the application of the first, ductile nickel layer.

16. A method in accordance with claim 8, wherein the cold-rolled strip is cold rolled in an intermediate step after the application of the first, ductile nickel layer.

17. The cold-rolled strip of claim 1 wherein the strip is made into a battery shell.
